(19) United States
(12) Patent Application Publication
(10) Pub. No.: US 2024/0312653 A1
(43) Pub. Date: Sep. 19, 2024

(54) INCLINED FUEL TRANSFER SYSTEM BETWEEN CONTAINMENT AND FUEL HANDLING BUILDING

(71) Applicant: Westinghouse Electric Company LLC, Cranberry Township, PA (US)

(72) Inventors: Jerzy CHRZANOWSKI, Cranberry Township, PA (US); Nancy Burns CLOSKY, Bridgeville, PA (US)

(73) Assignee: Westinghouse Electric Company LLC, Cranberry Township, PA (US)

(21) Appl. No.: 18/184,324

(22) Filed: Mar. 15, 2023

(51) Int. Cl. G21C 19/10

(52) U.S. Cl. CPC G21C 19/10

(57) ABSTRACT

Disclosed is a fuel transfer system comprises a first housing, a second housing, and a fuel transfer tube connecting the first housing to the second housing, wherein the fuel transfer tube is disposed at an elevational angle. The fuel transfer system comprises a fuel transfer cart configured to slidably move from the first housing to the second housing through the fuel transfer tube.

### TECHNICAL FIELD

The present disclosure is generally directed to nuclear reactors. More particularly the present disclosure is generally directed to a system for transferring nuclear fuel assemblies between a fuel handling building and a containment area which encloses the nuclear reactor.

### SUMMARY

The following summary is provided to facilitate an understanding of some of the innovative features unique to the aspects disclosed herein, and is not intended to be a full description. A full appreciation of the various aspects disclosed herein can be gained by taking the entire specification, claims, and abstract as a whole.

In one general aspect, the present disclosure provides a fuel transfer system comprises a first housing, a second housing, and a fuel transfer tube connecting the first housing to the second housing, wherein the fuel transfer tube is disposed at an elevational angle. The fuel transfer system comprises a fuel transfer cart configured to slidably move from the first housing to the second housing through the fuel transfer tube.

In another aspect, the present disclosure provides a fuel transfer system comprising a first housing, a second housing, and a fuel transfer tube connecting the first housing to the second housing, wherein the fuel transfer tube is disposed at an elevational angle. The fuel transfer system comprising a fuel transfer cart configured to slidably move from the first housing to the second housing through the fuel transfer tube and a reel comprising a cable, the cable connected to the fuel transfer cart. The reel is configured to slidably move the fuel transfer cart from the second housing to the first housing.

In another aspect, the present disclosure provides a fuel transfer system comprising a first housing, a second housing, and a fuel transfer tube connecting the first housing to the second housing, wherein the fuel transfer tube is disposed at an elevational angle. The fuel transfer system comprising a fuel transfer cart configured to slidably move from the first housing to the second housing through the fuel transfer tube. The fuel transfer system comprising a reel comprising a cable connected to the fuel transfer cart. The reel configured to release tension on the cable such that the fuel transfer cart passively slidably moves from the second housing to the first housing and apply tension on the cable such that the fuel transfer cart slidably moves from the second housing to the first housing.

### BRIEF DESCRIPTION OF THE FIGURES

The novel features of the various aspects are set forth with particularity in the appended claims. Throughout the figures like reference characters designate like or corresponding parts throughout the several views of the drawings. The described aspects, however, both as to organization and methods of operation, may be best understood by reference to the following description, taken in conjunction with the accompanying drawings in which:

FIG. 1 is a fuel transfer system, according to at least one aspect of the disclosure;

FIG. 2 is a first housing of the fuel transfer system shown in FIG. 1, according to at least one aspect of the disclosure; and

FIG. 3 is a second housing of the fuel transfer system shown in FIG. 1, according to at least one aspect of the disclosure.

### DESCRIPTION

Numerous specific details are set forth to provide a thorough understanding of the overall structure, function, manufacture, and use of the aspects as described in the disclosure and illustrated in the accompanying drawings. Well-known operations, components, and elements have not been described in detail so as not to obscure the aspects described in the specification. The reader will understand that the aspects described and illustrated herein are non-limiting examples, and thus it can be appreciated that the specific structural and functional details disclosed herein may be representative and illustrative. Variations and changes thereto may be made without departing from the scope of the claims. Furthermore, it is to be understood that such terms as “top,” “bottom,” “forward,” “rearward,” “left,” “right,” “upwardly,” “downwardly,” and the other such words are words of convenience and are not to be construed as limiting terms.

It should be noted that the illustrative examples are not limited in application or use to the details of construction and arrangement of parts illustrated in the accompanying drawings and description. The illustrative examples may be implemented or incorporated in other aspects, variations, and modifications, and may be practiced or carried out in various ways. Further, unless otherwise indicated, the terms and expressions employed herein have been chosen for the purpose of describing the illustrative examples for the convenience of the reader and are not for the purpose of limitation thereof. Also, it will be appreciated that one or more of the following-described aspects, expressions of aspects, and/or examples, can be combined with any one or more of the other following-described aspects, expressions of aspects, and/or examples.

The fuel for large nuclear reactors of the type used for generating electrical power, is contained in long, small diameter fuel rods or elements. Typically, fuel elements are disposed in a predetermined pattern in a fuel assembly with spaces provided for vertically adjustable control rods. When these fuel assemblies are set in position and the reactor placed in operation, the fission process generates heat and in so doing, consumes the fuel thus requiring removal and replacement of old fuel assemblies with new assemblies containing fresh fuel. Since fuel within the metallic rods and other supporting structures in each assembly become radioactive, the operation which effects transfer of old for new assemblies must be carried out underwater for personal protection. As with usual reactor constructions, the reactor head and associated components are removed, and the refueling cavity is flooded to a level sufficient to permit keeping the assembly submerged as the assembly is lifted vertically from the reactor core and transferred to a storage pool.

After reactor operation takes place for a predetermined period, the fuel in the fuel assemblies burns up, thus requiring replacement of spent fuel with fresh fuel in the new fuel assemblies. The assemblies containing spent fuel need to be removed from a first housing, and assemblies containing new fuel need to be moved into the first housing. The first housing and the second housing are flooded with water during the fuel transfer process. In order to move a fuel assembly from the first housing to the second housing, a fuel transfer tube equipped with rails and containment isolation features on each side is disposed between the first housing and the second housing to facilitate the movement of the fuel assembly. The fuel assembly is placed on a cart to transfer the fuel assembly from the first housing to the second housing.

Fuel transfer systems that operate under water, include the following main elements. An upender is located inside a containment on the bottom of a refueling cavity. The upender is employed to rotate the container with fuel assembly from vertical to horizontal position. The fuel assembly is placed into the container held in the vertical position by the upender. After the container with the fuel assembly is rotated to the horizontal position by upender, the cart carrying the container with the fuel assembly is transferred through a fuel transfer tube. The fuel transfer tube provides a connection between the containment and the spent fuel building. The upender on the fuel handling building side in the fuel handling area is located on the bottom of the fuel transfer canal. The fuel transfer canal is a pool filled with water for cooling and shielding purposes. The fuel transfer canal is drained when needed to repair the fuel transfer system.

A fuel transfer cart with a fuel container loaded thereon travels between the upenders on a track system. The fuel container is tilted from/to horizontal to/from vertical position by hydraulically driven upenders. A pusher applies force to insert/withdraw the fuel transfer cart to/from the containment through the fuel transfer tube. The track system provides a straight rigid path for the fuel transfer cart and the pusher. A winch, mechanical equipment provided to pull/withdraw the pusher and the fuel transfer cart using steel cables, is located above the water level in the fuel handing area. Power and hydraulic units provide power and hydraulic pressure to operate the system components described above.

In conventional configurations of pressurized water reactor the track, upenders, and fuel transfer tube are oriented horizontally relative to each other. Accordingly, to transfer the cart with the fuel assembly through the fuel transfer tube, the winch pulls the cables attached to the pusher. The pusher is coupled to the fuel transfer cart and forces the fuel transfer cart to move between the fuel handling area and the containment upenders as controlled by an operator. The length of the pusher is dictated by the distance between the upenders. Given that the pusher is rigid and coupled with the fuel transfer cart, the space required for the pusher in most withdrawal positions determines the length of the fuel transfer canal. The longer the distance between the upenders—the longer the pusher must be, and as a result—the longer the fuel transfer canal is required to be.

In various aspects, the present disclosure is directed to a fuel transfer system that eliminates the need for a pusher, and as a result minimizes the length of the fuel transfer canal and the size of the first housing. In one aspect, the entire track system and fuel transfer tube are inclined to allow the fuel transfer cart to be reel controlled while it is gravity rolled towards the lower upender. The fuel transfer cart transfer from the fuel handling area side through the fuel transfer tube is controlled by the release of the cable by the reel. In view of the transfer system controls and reel being located in the fuel handling area, the first upender in the first housing (fuel handling area) is at a higher elevation than the second upender in the second housing (containment side). Gravity allows the fuel transfer cart to roll down the track system from the first housing to the second housing (e.g., from the fuel handling area to the containment area). The fuel transfer cart is withdrawn from the second housing to the first housing by the reel pulling the cable. In one aspect, the cable is tensioned at all times to avoid losing contact with the pulleys and to prevent unwanted movement of the fuel transfer cart. In one aspect, a minimum of two sets of cables can be provided for redundancy purposes. Cables can be configured to be attached to the cart's center line to avoid side forces during movement. In one aspect, the cables can be attached to the track system.

The inclined track system configuration shortens the track system by an amount equal to length of the pusher. As a result, the length of the fuel transfer canal is reduced. In one aspect, the first upender, located in the fuel handling area, is equipped with a latch to prevent the fuel transfer cart from rolling down during unwanted times, such as during upending and fuel assembly insertion or withdrawal, or in case of cables break. In one aspect, the fuel transfer cart is equipped with shock absorber(s) to avoid fuel assembly damage in case the cables break during transfer. In one aspect, the track system end on the containment side is equipped with shock absorber(s) to avoid fuel assembly damage in case the cables break during transfer. In another aspect, the fuel transfer cart and the lower upender are both equipped with shock absorber(s) to avoid fuel assembly damage in case the cables break during transfer.

Upenders are provided to tilt the container to a vertical position in order to exchange a fuel assembly. The upenders tilt the fuel assembly container to a tilt angle of 90° minus the angle of the track system. The inclined position of the fuel transfer cart prevents the fuel assembly from sliding out from the container. The slope of the track can vary. In one aspect, the slope of the track is 5°. The depth of the first upender in the first housing is set to provide minimum water coverage above the active fuel when inserting the fuel assembly into the container.

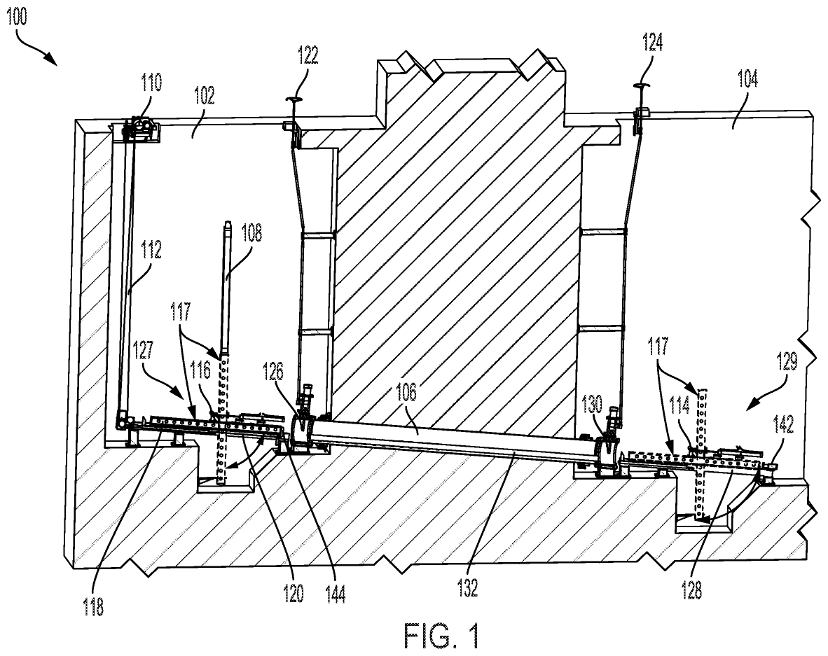

Referring now to the figures, a fuel transfer system 100 is shown in FIG. 1. The fuel transfer system 100 comprises a first housing 102, a second housing 104, and a fuel transfer tube 106 connecting the first housing 102 to the second housing 104. The fuel transfer tube 106 is disposed at an elevational angle. The fuel transfer system 100 also comprises a fuel transfer cart 118 configured to slidably move from the first housing 102 to the second housing 104 through the fuel transfer tube 106.

In one aspect, the first housing 102 is a fuel handling area. The fuel handling area houses storage facilities for new fuel assemblies to be transferred to the fuel handling area. The fuel handling area contains storage facilities for spent fuel assemblies which have been removed from the reactor and are awaiting shipment to a disposal area. Spent and partially burned fuel assemblies are transferred from the containment area. New fuel and partially burned assemblies are transferred into the containment area. A first track system 120 is disposed within the first housing 102. The first track system 120 is disposed at the elevational angle.

In one aspect, the second housing 104 is a containment area. The containment area contains a nuclear reactor and associated equipment (not shown) all of which are enclosed in a thick walled upstanding vessel. A second track system 128 is disposed within the second housing 104. The second track system 128 is disposed at the elevational angle.

A fuel transfer tube 106 is disposed at the elevational angle between the first housing 102 and the second housing 104. The fuel transfer tube 106 connects the first housing 102 to the second housing 104. In one aspect, a first end 127 of the fuel transfer tube 106 is disposed at a higher elevation than a second end 129 of the fuel transfer tube 106 to define the elevational angle. In one aspect, the fuel transfer cart 118 at the first end 127 has a higher potential energy than the fuel transfer cart 118 at the second end 129 of the fuel transfer tube 106. In one aspect, the first end 127 of the fuel transfer tube 106 is connected to the first housing 102 and the second end 129 of the fuel transfer tube 106 is connected to the second housing 104. The fuel transfer tube 106 has a third track system 132 disposed within the fuel transfer tube 106.

A fuel transfer cart 118 has a frame supported on wheels 140 which ride on the first track system 120, the second track system 128, and the third track system 132. The fuel transfer cart 118 with fuel container 117 is configured to carry the fuel assembly 108 between the first housing 102 and the second housing 104 through the fuel transfer tube 106. At the first end 127 of the fuel transfer tube 106, the cart 118 has a higher gravitational potential energy than at the second end 129 of the fuel transfer tube 106. In one aspect, the fuel transfer tube 106 is angled such that the cart is configured to passively slidably move from the first housing 102 through the fuel transfer tube 106 to the second housing 104. The fuel transfer tube 106 can be disposed at numerous elevational angles, any of which angles are suitable to allow the fuel transfer cart 118 to move passively from the first housing 102 to the second housing 104. In one aspect, the fuel transfer tube 106 is disposed at an elevational angle of five degrees. The third track system 132 is also configured to be disposed at the elevational angle. All three track systems 120, 128, 132 are aligned and disposed at the same angle.

Disposed in the first housing is a reel 110 and cable 112. The reel 110 comprises at least one cable 112 connected to the fuel transfer cart 118. In one aspect, the cable 112 can comprise a first cable and a second cable. The second cable can be employed as an emergency cable in case the first cable breaks.

A first gate valve 126 is located within the first housing 102. The first gate valve 126 is configured to isolate the fuel transfer tube 106. The first gate valve 126 is configured to be opened or closed by a first valve release 122. The first gate valve 126 is large enough to allow the fuel transfer cart 118 and with the fuel container 117 to pass through. The fuel container 117 is shown in four positions. The fuel container 117 shown in dashed lines indicates a position of the fuel container 117. The first gate valve 126 is configured to close to isolate the fuel handling area. The first gate valve 126 is configured to open in order to allow the transfer of the fuel transfer cart 118 with fuel container 117 through the fuel transfer tube 106.

A second gate valve 130 is located within the second housing 104. The second gate valve 130 is configured to isolate the fuel transfer tube 106. The second gate valve 130 is configured to be opened or closed by a second valve release 124. The second gate valve 130 is large enough to allow the fuel transfer cart 118 with fuel container 117 to pass through. The second gate valve 130 is configured to close in order to isolate the fuel transfer tube 106, or open to allow the transfer of the fuel transfer cart 118 with fuel container 117. Disposed in the first housing 102 is a first upender 116. The first upender 116 is configured to pivot a fuel container 117 for standing or laying the fuel assembly 108 as indicated by the arrows. In one aspect, the first upender comprises a latch 144 configured to prevent the fuel transfer cart 118 from slidably moving while the first upender 116 is pivoting. In one aspect, the latch 144 is configured to prevent the fuel transfer cart 118 from moving while the latch 144 is engaged with the fuel transfer cart 118.

Disposed in the second housing 104 is a second upender 114. The second upender 114 is configured to pivot the fuel container 117 as indicated by the arrows. In one aspect, the second track system 128 comprises a shock absorber 142 to absorb the shock from the fuel transfer cart 118. In another aspect, the fuel transfer cart 118 comprises a shock absorber to absorb the shock of the fuel transfer cart 118 sliding into the end of rail system 128. In another aspect, the fuel transfer cart 118 and the end of the rail system 128 comprise shock absorbers. An upender 114, 116 is configured to pivot a fuel container 117 from a vertical position to a second position, wherein the second position is disposed at an elevational angle of the fuel transfer cart 118. The second position allows the fuel container 117 to be transferred on the fuel transfer cart 118. An upender 114, 116 also can be configured to pivot the fuel container 117 from the second position to the vertical position.

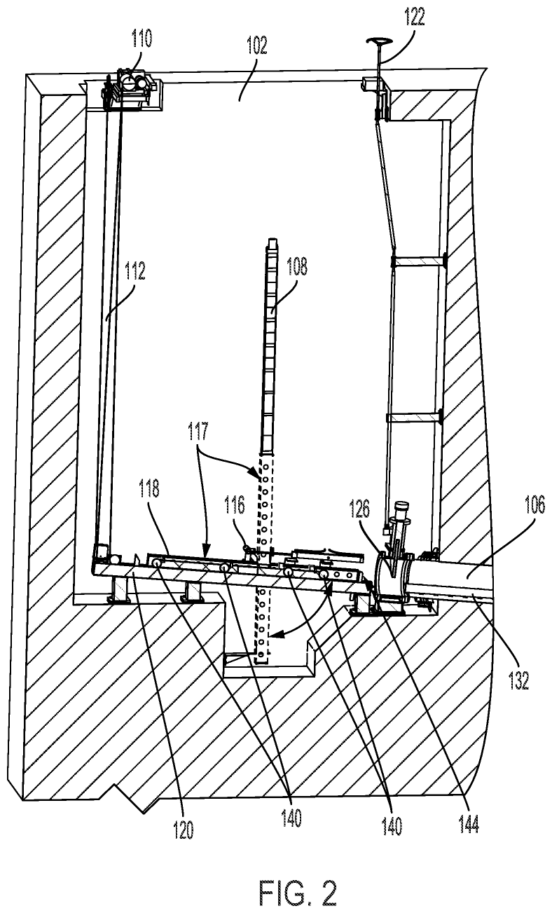

FIG. 2 is a first housing 102 of the fuel transfer system 100 shown in FIG. 1, according to at least one aspect of the disclosure. The first housing 102 includes the first upender 116, the fuel transfer cart 118, a first track system 120, a first gate valve 126, a first valve release 122, cables 112, and a reel 110. The fuel transfer cart 118 is configured to be traveling on the first track system 120 by its wheels 140. The fuel transfer cart 118 is configured to roll along the first track system 120 to transfer fuel assemblies. The same fuel container 117 is shown in both vertical and horizontal position. The fuel assembly 108 is shown in position just above the fuel container 117. The fuel transfer cart 118 with fuel container 117 are normally parked in the first housing 102 to allow both first and second gate valves 126, 130 to be closed when needed.

With reference now to FIGS. 1 and 2, the cable 112 is connected to the reel 110 and the fuel transfer cart 118. The reel 110 is configured to provide a tension on the cable 112. In one aspect, the reel 110 is configured to tension the cable 112 to prevent unwanted movement of the fuel transfer cart 118. In one aspect, the reel 110 is configured to release the tension on the cable 112, thus allowing the fuel transfer cart 118 to move along the first track system 120 toward the fuel transfer tube 106. The fuel transfer cart 118 is configured to move from the first housing 102 to the second housing 104 under the influence of gravity due the difference in potential energy between the first housing 102 and second housing 104 caused by the elevational angle between the first and second ends 127, 129 of the fuel transfer tube 106. In one aspect, the reel 110 is configured to move the fuel transfer cart 118 by providing a tension on the cable 112. The fuel transfer cart 118 is configured to move from the second housing 104 to the first housing 102 when the cable 112 is tensioned.

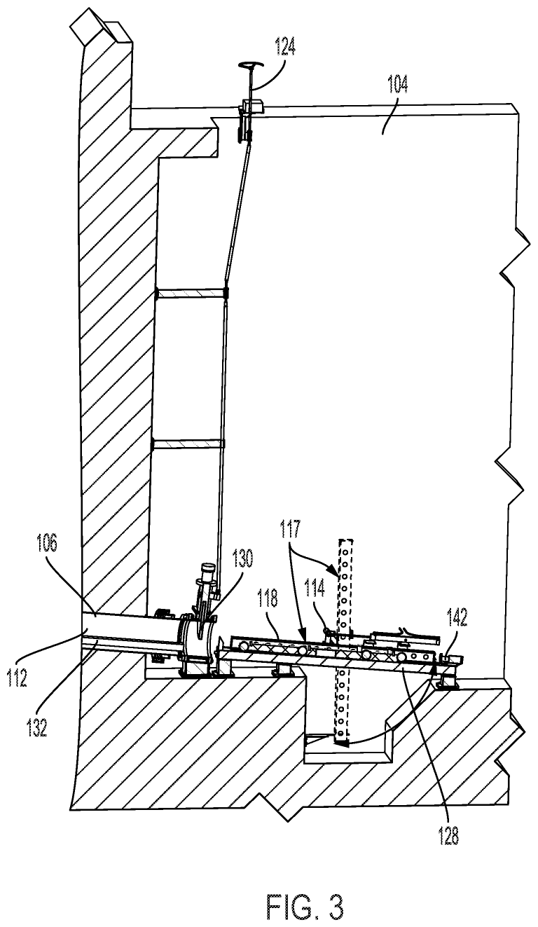

FIG. 3 is a second housing 104 of the fuel transfer system 100 shown in FIG. 1, according to at least one aspect of the disclosure. The second housing 104 includes the second upender 114, a second track system 128, a second gate valve 130, a second valve release 124, and the cable 112. The cable 112 is configured to connect to the fuel transfer cart 118 and extend from the first housing 102 (shown in FIGS. 1 and 2) to the second housing 104 through the fuel transfer tube 106. The fuel transfer cart 118 with fuel container 117 is shown in the second housing 104 in its temporary position for fuel assembly exchange. The same fuel container 117 is shown in both the vertical and horizontal position.

With reference now to FIGS. 1-3, in one aspect, the reel 110 is configured to tension the cable 112 to slidably move the fuel transfer cart 118 from the second housing 104 to the first housing 102. In one aspect, the reel 110 is configured to tension the cable 112 to prevent the fuel transfer cart 118 from slidably moving passively in the fuel transfer tube 106.

In one aspect, a reel 110 comprising a cable 112 connected to the fuel transfer cart 118. The reel 110 is configured to release tension on the cable 112 such that the fuel transfer cart 118 can passively slidably move from the first housing 102 to the second housing 104. The reel 110 is configured to tension the cable 112 such that the fuel transfer cart 118 can slidably move from the second housing 104 to the first housing 102.

The first upender 116 pivots the fuel container 117 as indicated by the arrows, and the fuel container 117 receives the fuel assembly 108. The first upender 116 pivots back the fuel container 117 with fuel assembly 108 to transport position within fuel transfer cart 118. The fuel transfer cart 118 slidably moves from the first upender 116 in the first housing 102 to the second housing 104 under the influence of gravity and the release of tension on the cable 112. The fuel transfer cart 118 moves from the first housing 102 through the fuel transfer tube 106 to the second housing 104. The fuel transfer cart 118 stops at the second upender 114 in the second housing 104. The second upender 114 pivots the fuel container 117 for fuel assembly removal.

In one aspect, the second upender 114 pivots the fuel container 117 as indicated by the arrows, and the fuel container 117 receives the fuel assembly 108. The second upender 114 pivots back the fuel container 117 with fuel assembly 108 to transport position within the fuel transfer cart 118. The fuel transfer cart 118 can slidably move from the second upender 114 in the second housing 104 to the first upender 116 in the first housing 102 by tensioning the cable 112 attached to the fuel transfer cart 118. The tension applied to the cable 112 by the reel 110 can move the fuel transfer cart 118 from the second housing 104 through the fuel transfer tube 106 to the first housing 102. The fuel transfer cart 118 stops at the first upender 116. The first upender 116 pivots the fuel container 117 to vertical position for fuel assembly removal.

### Examples

Various aspects of the subject matter described herein are set out in the following numbered examples.

Example 1—A fuel transfer system comprising a first housing, a second housing, and a fuel transfer tube connecting the first housing to the second housing, wherein the fuel transfer tube is disposed at an elevational angle. The fuel transfer system comprising a fuel transfer cart configured to slidably move from the first housing to the second housing through the fuel transfer tube.

Example 2—The fuel transfer system of example 1, wherein a first end of the fuel transfer tube is disposed at a higher elevation than a second end of the fuel transfer tube to define the elevational angle.

Example 3—The fuel transfer system of examples 1 or 2, comprising a first upender in the first housing, wherein the first upender comprises a latch configured to prevent the fuel transfer cart from slidably moving while the latch is engaged with the fuel transfer cart.

Example 4—The fuel transfer system of examples 1, 2, or 3, comprising a second upender in the second housing, wherein the second upender comprises a shock absorber to absorb shock from the fuel transfer cart.

Example 5—The fuel transfer system of examples 1, 2, 3, or 4, wherein the fuel transfer tube is disposed at the elevational angle such that the fuel transfer cart is configured to slidably move passively from the first housing to the second housing.

Example 6—The fuel transfer system of examples 1, 2, 3, 4, or 5, comprising a reel, the reel comprising a cable connected to the fuel transfer cart.

Example 7—The fuel transfer system of example 6, wherein the reel is configured to apply a tension to the cable to slidably move the fuel transfer cart from the second housing to the first housing.

Example 8—The fuel transfer system of examples 6 or 7, wherein the reel is configured to apply a tension to the cable to prevent the fuel transfer cart from slidably moving passively in the fuel transfer tube.

Example 9—A fuel transfer system comprising a first housing, a second housing, and a fuel transfer tube connecting the first housing to the second housing, wherein the fuel transfer tube is disposed at an elevational angle. The fuel transfer system comprising a fuel transfer cart configured to slidably move from the first housing to the second housing through the fuel transfer tube and a reel comprising a cable, the cable connected to the fuel transfer cart. The reel is configured to slidably move the fuel transfer cart from the second housing to the first housing.

Example 10—The fuel transfer system of example 9, comprising a first upender in the first housing, wherein the first upender comprises a latch configured to prevent the fuel transfer cart from slidably moving while the latch is engaged with the fuel transfer cart.

Example 11—The fuel transfer system of examples 9 or 10, comprising a second upender in the second housing, wherein the second upender comprises a shock absorber to absorb shock from the fuel transfer cart.

Example 12—The fuel transfer system of examples 9, 10, or 11, wherein the fuel transfer tube is disposed at the elevational angle such that the fuel transfer cart is configured to slidably move passively from the first housing to the second housing.

Example 13—The fuel transfer system of examples 9, 10, 11, or 12, wherein the reel is configured to apply a tension to the cable to slidably move the fuel transfer cart from the second housing to the first housing.

Example 14—The fuel transfer system of examples 9, 10, 11, 12, or 13 wherein the reel is configured to apply a tension to the cable to prevent the fuel transfer cart from slidably moving passively in the fuel transfer tube.

Example 15—A fuel transfer system comprising a first housing, a second housing, and a fuel transfer tube connecting the first housing to the second housing, wherein the fuel transfer tube is disposed at an elevational angle. The fuel transfer system comprising a fuel transfer cart configured to slidably move from the first housing to the second housing through the fuel transfer tube. The fuel transfer system comprising a reel comprising a cable connected to the fuel transfer cart. The reel configured to release tension on the cable such that the fuel transfer cart passively slidably moves from the second housing to the first housing and apply tension on the cable such that the fuel transfer cart slidably moves from the second housing to the first housing.

Example 16—The fuel transfer system of example 15, comprising a first upender in the first housing, wherein the first upender comprises a latch configured to prevent the fuel transfer cart from slidably moving while the latch is engaged with the fuel transfer cart.

Example 17—The fuel transfer system of examples 15 or 16, comprising a second upender in the second housing, wherein the second upender comprises a shock absorber to absorb shock from the fuel transfer cart.

Example 18—The fuel transfer system of examples 15, 16, or 17, wherein the fuel transfer tube is disposed at the elevational angle such that the fuel transfer cart is configured to slidably move passively from the first housing to the second housing.

Example 19—The fuel transfer system of examples 15, 16, 17, or 18, wherein the reel is configured to apply a tension to the cable to prevent the fuel transfer cart from slidably moving passively in the fuel transfer tube.

Example 20—The fuel transfer system of examples 15, 16, 17, 18, or 19, wherein the first housing is a fuel handling area and the second housing is a containment area.

All patents, patent applications, publications, or other disclosure material mentioned herein, are hereby incorporated by reference in their entirety as if each individual reference was expressly incorporated by reference respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference and the disclosure expressly set forth in the present application controls.

The aspects described herein are understood as providing illustrative features of varying detail of various aspects of the present disclosure; and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the present disclosure. Accordingly, it will be recognized by persons having ordinary skill in the art that various substitutions, modifications or combinations of any of the exemplary aspects may be made without departing from the scope of the disclosure. In addition, persons skilled in the art will recognize, or be able to ascertain using no more than routine experimentation, many equivalents to the various aspects of the present disclosure described herein upon review of this specification. Thus, the present disclosure is not limited by the description of the various aspects, but rather by the claims.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those aspects where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those aspects where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although claim recitations are presented in a sequence(s), it should be understood that the various operations may be performed in other orders than those which are described, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Directional phrases used herein, such as, for example and without limitation, top, bottom, left, right, lower, upper, front, back, and variations thereof, shall relate to the orientation of the elements shown in the accompanying drawing and are not limiting upon the claims unless otherwise expressly stated.

The terms “about” or “approximately” as used in the present disclosure, unless otherwise specified, means an acceptable error for a particular value as determined by one of ordinary skill in the art, which depends in part on how the value is measured or determined. In certain aspects, the term “about” or “approximately” means within 1, 2, 3, or 4 standard deviations. In certain aspects, the term “about” or “approximately” means within 50%, 200%, 105%, 100%, 9%, 8%, 7%, 6%, 5%, 4%, 3%, 2%, 1%, 0.5%, or 0.05% of a given value or range.

In this specification, unless otherwise indicated, all numerical parameters are to be understood as being prefaced and modified in all aspects by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of “1 to 100” includes all sub-ranges between (and including) the recited minimum value of 1 and the recited maximum value of 100, that is, having a minimum value equal to or greater than 1 and a maximum value equal to or less than 100. Also, all ranges recited herein are inclusive of the end points of the recited ranges. For example, a range of “1 to 100” includes the end points 1 and 100. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system that “comprises,” “has,” “includes” or “contains” one or more elements possesses those one or more elements, but is not limited to possessing only those one or more elements. Likewise, an element of a system, device, or apparatus that “comprises,” “has,” “includes” or “contains” one or more features possesses those one or more features, but is not limited to possessing only those one or more features.

What is claimed is:

1. A fuel transfer system comprising:
a first housing;
a second housing;
a fuel transfer tube connecting the first housing to the second housing, wherein the fuel transfer tube is disposed at an elevational angle; and
a fuel transfer cart configured to slidably move from the first housing to the second housing through the fuel transfer tube.

2. The fuel transfer system of claim 1, wherein a first end of the fuel transfer tube is disposed at a higher elevation than a second end of the fuel transfer tube to define the elevational angle.

3. The fuel transfer system of claim 1, comprising a first upender in the first housing, wherein the first upender comprises a latch configured to prevent the fuel transfer cart from slidably moving while the latch is engaged with the fuel transfer cart.

4. The fuel transfer system of claim 1, comprising a second upender in the second housing, wherein the second upender comprises a shock absorber to absorb shock from the fuel transfer cart.

5. The fuel transfer system of claim 1, wherein the fuel transfer tube is disposed at the elevational angle such that the fuel transfer cart is configured to slidably move passively from the first housing to the second housing.

6. The fuel transfer system of claim 1, comprising a reel, the reel comprising a cable connected to the fuel transfer cart.

7. The fuel transfer system of claim 6, wherein the reel is configured to apply a tension to the cable to slidably move the fuel transfer cart from the second housing to the first housing.

8. The fuel transfer system of claim 6, wherein the reel is configured to apply a tension to the cable to prevent the fuel transfer cart from slidably moving passively in the fuel transfer tube.

9. A fuel transfer system comprising:
a first housing;
a second housing;
a fuel transfer tube connecting the first housing to the second housing, wherein the fuel transfer tube is disposed at an elevational angle;
a fuel transfer cart configured to slidably move from the first housing to the second housing through the fuel transfer tube; and
a reel comprising a cable, the cable connected to the fuel transfer cart, the reel configured to slidably move the fuel transfer cart from the second housing to the first housing.

10. The fuel transfer system of claim 9, comprising a first upender in the first housing, wherein the first upender comprises a latch configured to prevent the fuel transfer cart from slidably moving while the latch is engaged with the fuel transfer cart.

11. The fuel transfer system of claim 9, comprising a second upender in the second housing, wherein the second upender comprises a shock absorber to absorb shock from the fuel transfer cart.

12. The fuel transfer system of claim 9, wherein the fuel transfer tube is disposed at the elevational angle such that the fuel transfer cart is configured to slidably move passively from the first housing to the second housing.

13. The fuel transfer system of claim 9, wherein the reel is configured to apply a tension to the cable to slidably move the fuel transfer cart from the second housing to the first housing.

14. The fuel transfer system of claim 9, wherein the reel is configured to apply a tension to the cable to prevent the fuel transfer cart from slidably moving passively in the fuel transfer tube.

15. A fuel transfer system comprising:
a first housing;
a second housing;
a fuel transfer tube connecting the first housing to the second housing, wherein the fuel transfer tube is disposed at an elevational angle;
a fuel transfer cart configured to slidably move from the first housing to the second housing through the fuel transfer tube;
a reel comprising a cable connected to the fuel transfer cart, the reel configured to:
release tension on the cable such that the fuel transfer cart passively slidably moves from the second housing to the first housing; and
apply tension on the cable such that the fuel transfer cart slidably moves from the second housing to the first housing.

16. The fuel transfer system of claim 15, comprising a first upender in the first housing, wherein the first upender comprises a latch configured to prevent the fuel transfer cart from slidably moving while the latch is engaged with the fuel transfer cart.

17. The fuel transfer system of claim 15, comprising a second upender in the second housing, wherein the second upender comprises a shock absorber to absorb shock from the fuel transfer cart.

18. The fuel transfer system of claim 15, wherein the fuel transfer tube is disposed at the elevational angle such that the fuel transfer cart is configured to slidably move passively from the first housing to the second housing.

19. The fuel transfer system of claim 15, wherein the reel is configured to apply a tension to the cable to prevent the fuel transfer cart from slidably moving passively in the fuel transfer tube.

20. The fuel transfer system of claim 15, wherein the first housing is a fuel handling area and the second housing is a containment area.
